(19) United States
(12) Patent Application Publication
(10) Pub. No.: US 2025/0049231 A1
(43) Pub. Date: Feb. 13, 2025

(54) REFRIGERATOR APPLIANCE AND AIR CURTAIN ATTACHMENT

(71) Applicant: ILLINOIS TOOL WORKS INC., Glenview, IL (US)

(72) Inventors: Adam MARTIN, Norfolk (GB); Gareth HUNT, Norfolk (GB)

(21) Appl. No.: 18/799,521

(22) Filed: Aug. 9, 2024

(30) Foreign Application Priority Data
Aug. 11, 2023 (GB) 2312351.6

(51) Int. Cl. A47F 3/00; A47F 3/04

(52) U.S. Cl. CPC A47F 3/001; A47F 3/0408; A47F 3/043; A47F 3/0486

(57) ABSTRACT

A refrigerator appliance includes a cabinet with at least one shelf for displaying products, and a refrigeration system for cooling the cabinet. The at least one shelf includes a front edge located at a front of the cabinet, and an illumination strip extending parallel to the front edge and disposed at or near the front edge to illuminate products on the at least one shelf.

### BACKGROUND

Refrigerator appliances, particularly those used at point-of-sale or to display products (commonly referred to as multideck refrigerators or display chillers), typically include shelves on which products are stored. An air curtain may be generated in front of the shelves to improve temperature control over the products on the shelves, particularly if the refrigerator appliance is open-fronted (i.e., with a door).

In known refrigerator appliances products are illuminated by light sources mounted within the cabinet of the refrigerator appliance. It is known to mount the light sources at the top of the cabinet, at the sides of the cabinet, and/or on the undersides of the shelves. However, each of these positions has a disadvantage in terms of poor illumination of the products, creation of shadows and/or glare, and/or generating heat within the temperature-controlled region of the refrigerator appliance.

### SUMMARY

According to the present invention there is provided a refrigerator appliance. The refrigerator appliance includes a cabinet with at least one shelf for displaying products, and a refrigeration system for cooling the cabinet. The at least one shelf includes a front edge located at a front of the cabinet, and an illumination strip extending parallel to the front edge and disposed at or near the front edge to illuminate products on the at least one shelf.

Advantageously, positioning the illumination strip at or near to the front edge so that it extends parallel to the front edge provides improved illumination of products on the shelf as there are no other features to block the light or create shadows. Due to the position on the front edge of the shelf the illumination strip will primarily illuminate the front row of products on the shelf, improving the visibility and presentation of these products to consumers/users.

In examples, the illumination strip has a primary illumination direction that is non-parallel and non-perpendicular to the shelf. In examples, the illumination strip is oriented such that the primary illumination angle is between 10 degrees and 70 degrees relative to the shelf. Accordingly, the illumination strip provides uplighting for products on the shelf.

In examples, the illumination strip includes an LED light strip. The LED light strip preferably comprises a plurality of LEDs arranged in a line, mounted along a substrate. In examples, the illumination strip includes a diffuser at least partly overlying the illumination strip. The diffuser may improve illumination of the products on the shelf by diffusing the light from the illumination strip to provide homogeneous lighting, preventing undesirable spotting.

In examples, the refrigerator appliance also includes a cavity extending along the front edge of the shelf. The cavity may include a slot opening, and the illumination strip may be housed within the cavity and directed to emit light through the slot opening. The slot opening may be angled with respect to the shelf (non-parallel and non-perpendicular).

In examples, the illumination strip is attached to the front edge of the shelf. In such an example, the refrigerator appliance may further comprise a removable cover that is attachable to the front edge of the shelf to define the cavity. In this way, the illumination strip may be directly attached to the front edge of the shelf, and the removable cover may be attached to the shelf to surround the illumination strip. The illumination strip may comprise a profiled housing within which a plurality of LEDs are housed. The profiled housing may include the slot opening (e.g., the housing has a U-shaped profile or similar). A diffuser may be part of the profiled housing, for example covering the slot opening. The profiled housing may directly attach to the front edge of the shelf, for example by screws, rivets, welding, or similar.

In examples, the refrigerator appliance may further comprise an air curtain attachment attachable to the front edge of the shelf adjacent to the illumination strip and removable cover. Therefore, the illumination strip and removable cover can be attached to the shelf without the air curtain attachment.

In examples, the refrigerator appliance also includes an air curtain attachment attachable to the front edge of the shelf, the air curtain attachment includes the illumination strip. The air curtain attachment may act to guide or sustain an air curtain at the front of the shelf.

Advantageously, the position of the illumination strip extending along the front edge of the shelf means that it is immediately adjacent to, or even within, the flow of air forming the air curtain. This may prevent heat from the illumination strip from warming the refrigerated space as any heat generated by the illumination strip will be conveyed away from the shelf by the air curtain. This combination of the position of the illumination strip and the air curtain provides the dual advantages of improved product illumination and improved thermal management and appliance efficiency.

In examples, the air curtain attachment comprises an attachment portion for attaching to the front edge of the shelf, and an air deflecting member mounted to the attachment portion by a support arm such that the air deflecting member is spaced from the attachment portion to define an air curtain passage between the air deflecting member and the attachment portion. The air curtain is guided between the attachment portion and the air deflecting member to maintain the air curtain in front of the shelf. The air deflecting member acts like an aerofoil to create a low pressure area within the air curtain passage, helping to guide the air curtain through the air curtain passage and sustain the air curtain as it travels past the front of the shelf.

In examples, the illumination strip is located such that in use it is disposed within, or adjacent to, the air curtain passage. The illumination strip may be disposed on an inside or outside of the air curtain.

In examples, the illumination strip is disposed on the attachment portion. In examples, the attachment portion defines a cavity having a slot opening, and wherein the illumination strip is received within the cavity and directed to emit light through the slot opening. In examples, the refrigerator appliance further comprises a removable cover defining a part of the cavity. The removable cover may be shaped to deflect the air curtain towards the air curtain passage. In this example the illumination strip is located adjacent to the air curtain, but some of the air flow may pass over the illumination strip and/or cover and convey heat away from the illumination strip.

In other examples, the illumination strip is disposed on the air deflecting member. In examples, the air deflecting member comprises a cavity and a slot opening, and the illumination strip is received within the cavity and directed to emit light through the slot opening. In this example, the illumination strip is located within the air curtain as some of the air flow will pass over the air deflecting member and convey heat away from the illumination strip. In addition, the majority of the air flow forming the air curtain is between the illumination strip and the refrigerated space, meaning that heat transfer from the illumination strip to the refrigerated space is greatly reduced.

In examples, the refrigerator appliance further comprises an air outlet disposed at a top of the cabinet and arranged to generate an air curtain at the front of the cabinet. The air outlet may receive air from the refrigeration system via an air channel in the refrigerator appliance. The air outlet may comprise a vent, in particular a honeycomb vent, to direct air downwards in an air curtain. The refrigerator appliance may comprise an air intake located at the bottom of the front of the cavity to receive the air curtain.

In examples, the refrigerator appliance includes a plurality of shelves, each shelf having a front edge and an illumination strip extending parallel to the front edge and disposed at or near the front edge to illuminate products on the at least one shelf.

According to a further aspect of the present invention there is provided an air curtain attachment for a refrigerator appliance. The air curtain attachment includes an attachment portion for attaching to a front edge of a shelf of the refrigerator appliance, an air deflecting member mounted to the attachment portion by support arm such that the air deflecting member is spaced from the attachment portion to define an air curtain passage between the air deflecting member and the attachment portion, and an illumination strip arranged to illuminate products on the shelf when the air curtain attachment is attached to the front edge of the shelf by the attachment portion.

In use, the air curtain is guided between the attachment portion and the air deflecting member to maintain the air curtain in front of the shelf. The air deflecting member acts like an aerofoil to create a low pressure area within the air curtain passage, helping to guide the air curtain through the air curtain passage and sustain the air curtain as it travels past the front of the shelf.

In examples, the illumination strip is located such that in use it is disposed within, or adjacent to, the air curtain passage. The illumination strip may be disposed on an inside or outside of the air curtain. Advantageously, the position of the illumination strip on the air deflecting member means that any heat generated by the illumination strip is prevented from entering the refrigerated spaced by the air curtain, and the heat may be conveyed away from the shelf by the air curtain. This combination of the position of the illumination strip and the air curtain provides the dual advantages of improved product illumination and improved thermal management and appliance efficiency.

In examples, the illumination strip is disposed on the attachment portion. In examples, the attachment portion defines a cavity having a slot opening, and wherein the illumination strip is housed within the cavity and directed to emit light through the slot opening. In examples, the air curtain attachment further comprises a removable cover defining a part of the cavity. The removable cover may be shaped to deflect the air curtain towards the air curtain passage. In this example the illumination strip is located adjacent to the air curtain, but some of the air flow may pass over the illumination strip and/or cover and convey heat away from the illumination strip.

In other examples, the illumination strip is disposed on the air deflecting member. The air deflecting member may comprise a cavity having a slot opening, and the illumination strip may be housed within the cavity and directed to emit light through the slot opening. In this example, the illumination strip is located within the air curtain as some of the air flow will pass over the air deflecting member and convey heat away from the illumination strip. In addition, the majority of the air flow forming the air curtain is between the illumination strip and the refrigerated space, meaning that heat transfer from the illumination strip to the refrigerated space is greatly reduced. In examples, the illumination strip has a primary illumination direction angled towards the shelf when the air curtain attachment is attached to the shelf. In examples, the illumination strip is oriented such that the primary illumination angle is between 10 degrees and 70 degrees relative to the shelf. Accordingly, the illumination strip provides uplighting for products on the shelf.

Other technical features may be readily apparent to one skilled in the art from the following figures, descriptions, and claims.

### BRIEF DESCRIPTION OF THE DRAWINGS

Examples of the invention are described, by way of example only, with reference to the accompanying drawings, in which:

FIG. 1 illustrates a refrigerator appliance.

FIG. 2 illustrates an example shelf of a refrigerator appliance, including an LED light strip mounted at the front edge of the shelf.

FIG. 3 illustrates a further example shelf of a refrigerator appliance with an air curtain attachment mounted to the front edge, the air curtain attachment including an Illumination strip.

FIG. 4 illustrates a further example shelf with an air curtain attachment having an Illumination strip and a removable cover.

FIG. 5 illustrates a further example shelf of a refrigerator appliance with an air curtain attachment mounted to the front edge, the air curtain attachment including an LED light strip.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g., central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

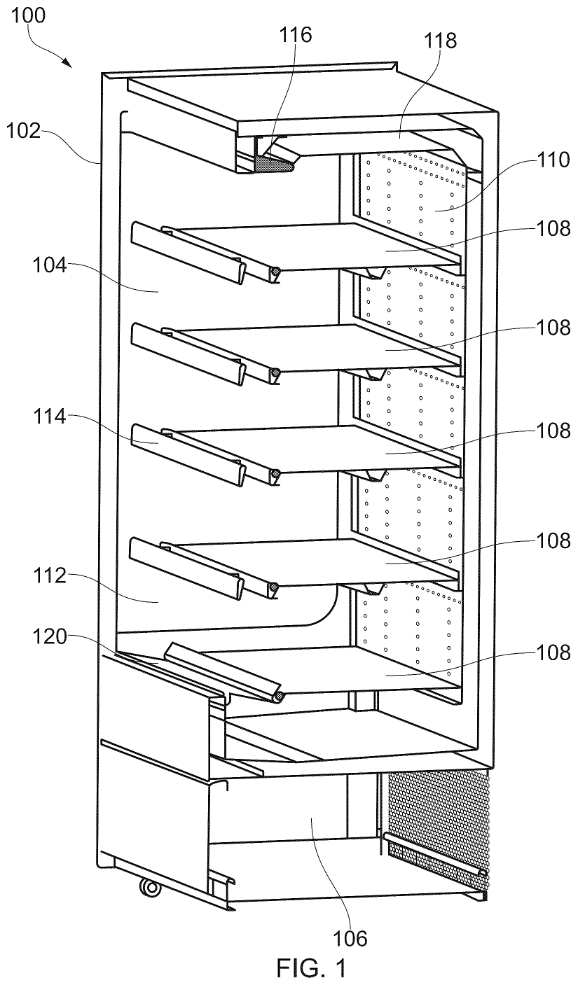

FIG. 1 shows a refrigerator appliance 100 having a cabinet 102. The cabinet 102 includes a refrigerated space 104 that is refrigerated by a refrigeration unit (not shown) housed in the plant space 106. In this example the plant space 106 is located at the bottom of the refrigerator appliance 100, but in various examples may be located elsewhere. In this example, the refrigerator appliance 100 is open-fronted, i.e., without a door. However, in other examples the refrigerator appliance 100 may comprise one or more doors arranged at the front 112 of the refrigerator appliance 100.

The refrigerator appliance 100 includes a plurality of shelves 108 located in the cabinet 102. The shelves 108 are mounted to the rear wall 110 and may additionally or alternatively be supported on side walls of the cabinet 102. The arrangement of the plurality of shelves 108 may be referred to as a multideck appliance.

As described further hereinafter, each shelf 108 includes a front edge 114 located at the front 112 of the cabinet 102. One or more of the shelves 108 includes an Illumination strip arranged to illuminate products held on the shelves 108.

Also shown in FIG. 1, the refrigerator appliance 100 had an optional air curtain. Specifically, the refrigerator appliance 100 includes an air outlet 116 arranged at the top of the cabinet 102 and directed downwards to create an air curtain at the front 112 of the refrigerated space 104. The air curtain is located in front of the front edges 114 of the shelves 108. Air is provided to the air outlet 116 from a fan in the plant space 106 via an air channel 118. Air travels from the air outlet 116, across the front of the refrigerated space 104, to an air intake 120 located at the bottom of the cabinet 102. The air curtain improves temperature management in the refrigerated space 104 by reducing or eliminating heat loss through convection.

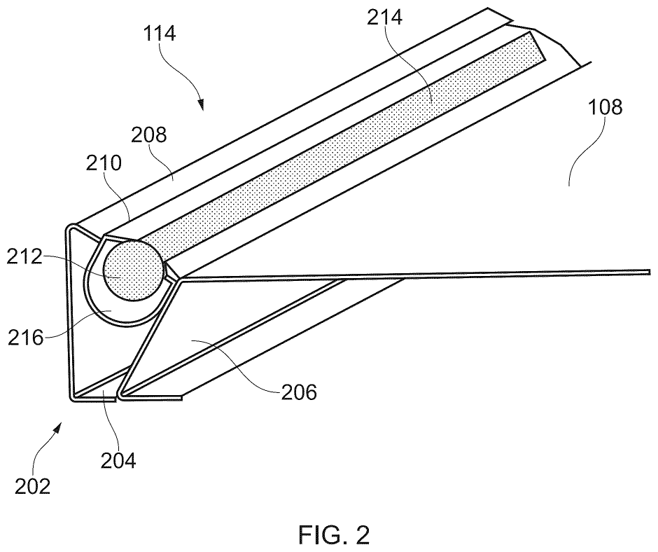

FIG. 2 illustrates an example shelf 108 for the refrigerator appliance 100 of FIG. 1. The shelf 108 includes a front edge 114 located at the front of the refrigerated space 104 shown in FIG. 1. Only the front of the shelf 108 is illustrated. A shelf front assembly 202 is provided on the front edge 114.

As shown, the shelf front assembly 202 includes a cavity 204 extending along the front edge 114 of the shelf 108. The cavity 204 is formed partly by a bent portion 206 of the shelf 108, and partly from a cover 208 attached to the bent portion 206. The cover 208 may be removable. The bent portion 206 and the cover 208 together define the cavity 204.

A slot opening 210 extends along the cavity 204 adjacent to the front edge 114 of the shelf 108. The slot opening 210 may be a gap between the bent portion 206 and the cover 208, or may be an opening in the cover 208. The slot opening 210 is in a plane that is angled with respect to the shelf 108, towards the shelf 108.

An illumination strip 212 is disposed in the cavity 204, between the bent portion 206 and the cover 208. The illumination strip 212 is directed towards the slot opening 210 to emit light out of the slot opening 210. The angle of the slot opening 210 and the corresponding position of the illumination strip 212 means that light is directed onto the products on the shelf 108. Preferably, the illumination strip 212 has a primary illumination direction that is between 10 degrees and 70 degrees relative to the plane of the shelf 108. Accordingly, products on the shelf 108 are illuminated by the illumination strip 212.

A diffuser 214 may be located over the slot opening 210 to diffuse light from the illumination strip 212, to improve evenness of the illumination and prevent light spotting and shadows.

Insulation 216 may surround the illumination strip 212 within the cavity 204. The insulation can prevent heat from the illumination strip 212 from warming the refrigerated space 104 (see FIG. 1).

In some examples, the shelf 108 illustrated in FIG. 2 is used in a refrigerator appliance 100 having an air curtain, as described with reference to FIG. 1. Advantageously, the air curtain is disposed in front of the shelf 108, adjacent to the front edge 114, and may flow over the cover 208. Flow of the air curtain over the cover 208 may help to dissipate heat generated by the illumination strip 212 and reduce heat transfer from the illumination strip 212 to the refrigerated space 104 (see FIG. 1).

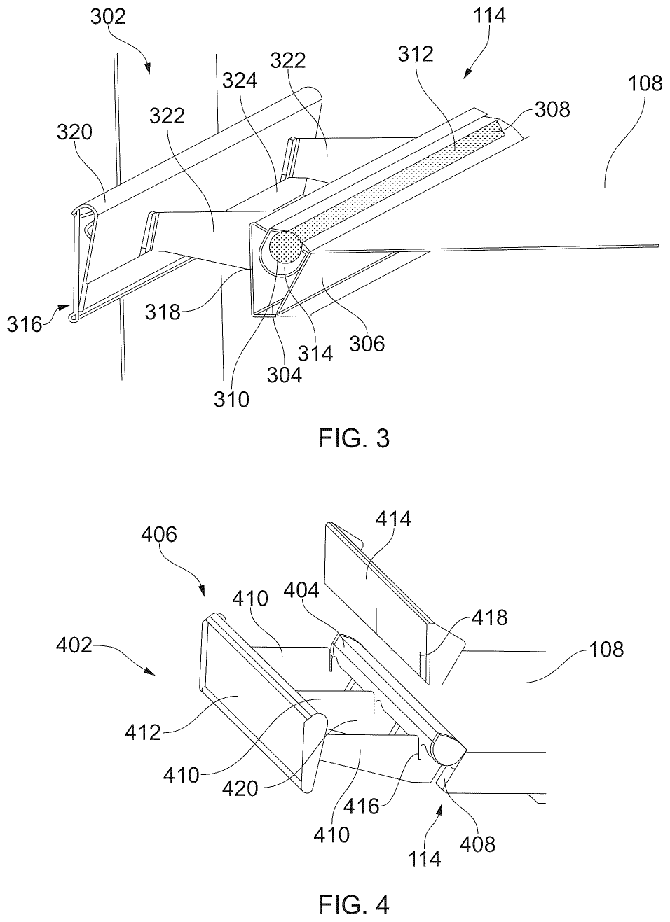

In the example of FIG. 3 the shelf 108 includes shelf front assembly 302 that partly is similar to that of FIG. 2. The shelf front assembly 302 includes a bent portion 306 extending from the shelf 108 and an attachment portion 318. The bent portion 306 and the attachment portion 318 together define a cavity 304 therebetween. The cavity 304 extends along the front edge 114 of the shelf 108.

As with the example of FIG. 2, an illumination strip 310 is housed in the cavity 304 and emits light towards products on the shelf 108 through slot opening 308 and optional diffuser 312. Insulation 216 may surround the illumination strip 310 within the cavity 304.

In some examples the illumination strip 310 may be mounted to the bent portion 306, and the attachment portion 318 may also attach to the bent portion 306, over the illumination strip 310. In other examples, the illumination strip 310 may be attached to the attachment portion 318 and together the attachment portion 318 and illumination strip 310 can be attached to the bent portion 306. The attachment portion 318 may be attached to the bent portion 306 by one or more fasteners (e.g., screws) or by a clipping or hooking arrangement.

Preferably, the illumination strip 310 has a primary illumination direction that is between 10 degrees and 70 degrees relative to the plane of the shelf 108. Accordingly, products on the shelf 108 are illuminated by the illumination strip 310.

In this example, the shelf front assembly 302 includes an air curtain attachment 316. The air curtain attachment 316 includes the attachment portion 318 that partly defines the cavity 304. The air curtain attachment 316 also includes an air deflecting member 320 mounted to the attachment portion 318 by support arms 322. The air deflecting member 320 is thereby spaced from the attachment portion 318 and an air curtain passage 324 is defined between the attachment portion 318 and the air deflecting member 320. The air deflecting member 320 may improve the air curtain by deflecting or guiding air into the air curtain passage 324 to prevent turbulence and other disturbances that may disrupt the flow of air along the air curtain. In some examples, the air deflecting member 320 may act as an aerofoil to create a low pressure area within the air curtain passage 324, helping to guide the air curtain through the air curtain passage 324 and sustain the air curtain as it travels past the front edge 114 of the shelf 108.

Advantageously, the arrangement of FIG. 3 provides a shelf front assembly 302 that includes an air curtain attachment 316 and an integrated illumination strip 310 for illumination of products on the shelf 108. The flow of the air curtain over the attachment portion 318 can convey heat from the illumination strip 310 away from the refrigerated space 104 (see FIG. 1), thus reducing or eliminating heating of the refrigerated space 104 by the illumination strip 310.

In the example of FIG. 4 the shelf 108 includes a shelf front assembly 402 similar to that of FIG. 3. In this example the shelf front assembly 402 includes an attachment portion 408 that attaches to the shelf 108, and an air curtain attachment 406 mounted on support arms 410.

In this example the ends of the support arms 410 form the attachment portion 408, which is directly attached to the front edge 114 of the shelf 108, for example by fasteners or by a hooking or clipping arrangement. The illumination strip 404 is attached to the support arm 410 and/or to the front edge 114 of the shelf 108 to hold it in place across the front edge 114.

In some examples, the illumination strip 404 includes its own housing, and may be attached to the front edge 114 of the shelf 108. In particular, the illumination strip 404 may be fastened, for example screwed or riveted, to the front edge 114 of the shelf 108. For example the illumination strip 404 may comprise a profiled housing within which a plurality of LEDs are located. The profiled housing may include a diffuser. The profiled housing may be attached to the front edge 114 of the shelf 108, thereby holding the LEDs in position.

In such an example, the support arms 410 may be attached to the front edge 114 of the shelf 108 below the illumination strip 404. In this way, the illumination strip 404 can be directly attached to the front edge 114 of the shelf 108 and can be used with or without the support arms 410 and other features of the air curtain attachment 406.

A removable cover 414 is positionable to partially enclose the illumination strip 404 and provide an air deflecting surface for the air curtain. When the removable cover 414 is attached over the illumination strip 404 the illumination strip 404 is disposed in a cavity defined by the removable cover 414. An air curtain passage 420 is defined between the removable cover 414 and the air deflecting member 412 for the air curtain.

The removable cover 414 includes mounting slots 418 that engage corresponding mounting slots 416 on the support arms 410 to fix the removable cover 414 in place. When the removable cover 414 is attached an opening is defined between the removable cover 414 and the shelf 108 for light from the illumination strip 404 to pass through to illuminate the products on the shelf 108. Preferably, the illumination strip 404 has a primary illumination direction that is between 10 degrees and 70 degrees relative to the plane of the shelf 108. Accordingly, products on the shelf 108 are illuminated by the illumination strip 404. The illumination strip 404 may include its own housing that may optionally include a diffuser and insulation similar to as described above.

Advantageously, the arrangement of FIG. 4 provides a shelf front assembly 402 that includes an air curtain attachment 406 and an integrated illumination strip 404 for illumination of products on the shelf 108. The flow of the air curtain over the removable cover 414 can convey heat from the illumination strip 404 away from the refrigerated space 104 (see FIG. 1), thus reducing or eliminating heating of the refrigerated space 104 by the illumination strip 404. The removable cover 414 may be removed for cleaning and/or access to the illumination strip 404 for maintenance.

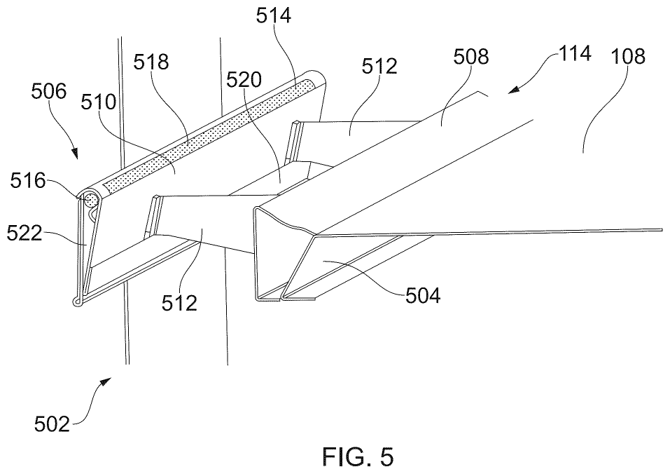

The example of FIG. 5 is similar to that of FIG. 3 and FIG. 4 in that the shelf 108 includes a shelf front assembly 502 that includes an attachment portion 508 and an air curtain attachment 506. In this example the attachment portion 508 attaches to the bent portion 504 of the shelf 108 to attach the shelf front assembly 502 to the shelf 108. Support arms 512 extend from the attachment portion 508 and an air deflecting member 510 is mounted to the support arm 512. The air deflecting member 510 is spaced from the attachment portion 508 defining an air curtain passage 520 therebetween.

In this example, an illumination strip 516 is mounted within the air deflecting member 510. The air deflecting member 510 has a cavity 522. The air deflecting member 510 is formed of a shaped profile with the cavity 522 formed internally. The air deflecting member 510 includes a slot opening 514 extending along at least a part of the air deflecting member 510. The illumination strip 516 is mounted within the cavity 522 of the air deflecting member 510 and arranged to emit light through the slot opening 514. A diffuser 518 is provided over the slot opening 514, and the illumination strip 516 may include insulation. Preferably, the illumination strip 516 has a primary illumination direction that is between 10 degrees and 70 degrees relative to the plane of the shelf 108.

Advantageously, in the example of FIG. 5 the illumination strip 516 is located on the air deflecting member 510, which is on the outer side of the air curtain passage 520. Therefore, any heat generated by the illumination strip 516 does not heat the refrigerated space 104 (see FIG. 1). Specifically, a part of the air flow forming the air curtain will pass over the air deflecting member 510 and convey heat away from the illumination strip 516 and shelf 108. In addition, most of the air flow forming the air curtain passes through the air curtain passage 520, which is between the illumination strip 516 and the shelf 108, which creates a barrier for heat transfer from the illumination strip 516 to the shelf 108 and so greatly reduces heat transfer.

It will be appreciated that the example shelf front assemblies 202, 302, 402, 502 of any of FIG. 2 to FIG. 5 may be provided on one or more of the shelves 108 of the refrigerator appliance 100 shown in FIG. 1. In addition, the refrigerator appliance 100 shown in FIG. 1 may include any combination of the shelf front assemblies 202, 302, 402, 502 of any of FIG. 2 to FIG. 5 on different shelves 108.

The illumination strips 212, 310, 404, 516 described above are preferably an LED light strip comprising a plurality of LEDs spaced along a substrate. An LED light strip advantageously provides low energy lighting with low heat generation. However, it will be appreciated that other forms of illumination strip may alternatively be used, for example including halogen lamps, fluorescent tubes, or high-intensity discharge lamps. In each example, the illumination strip 212, 310, 404, 516 may have a primary illumination direction, which is the direction of maximum illumination, or the average direction of illumination. The primary illumination direction may be inherent to the illumination strip 212, 310, 404, 516 itself, or may be a result of the housing of the illumination strip 212, 310, 404, 516 (e.g., within the cavity 204, 304, 522 as described above.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

Aspects of the present disclosure are provided in the following numbered clauses:

Clause 1. A refrigerator appliance comprising a cabinet with at least one shelf for displaying products, and a refrigeration system for cooling the cabinet, wherein the at least one shelf comprises a front edge located at a front of the cabinet, and an illumination strip extending parallel to the front edge and disposed at or near the front edge to illuminate products on the at least one shelf.

Clause 2. The refrigerator appliance of clause 1, wherein the illumination strip has a primary illumination direction that is non-parallel and non-perpendicular to the shelf.

Clause 3. The refrigerator appliance of clause 2, wherein the illumination strip is oriented such that the primary illumination angle is between 10 degrees and 70 degrees relative to the shelf.

Clause 4. The refrigerator appliance of any one of clauses 1 to 3, wherein the illumination strip comprises an LED light strip.

Clause 5. The refrigerator appliance of any one of clauses 1 to 4, wherein the illumination strip comprises a diffuser at least partly overlying the illumination strip.

Clause 6. The refrigerator appliance of any one of clauses 1 to 5, comprising a cavity extending along the front edge of the shelf, the cavity comprising a slot opening, and wherein the illumination strip is housed within the cavity and directed to emit light through the slot opening.

Clause 7. The refrigerator appliance of any one of clauses 1 to 5, comprising an air curtain attachment attachable to the front edge of the shelf, the air curtain attachment comprising the illumination strip.

Clause 8. The refrigerator appliance of clause 7, wherein the air curtain attachment comprises an attachment portion for attaching to the front edge of the shelf, and an air deflecting member mounted to the attachment portion by a support arm such that the air deflecting member is spaced from the attachment portion to define an air curtain passage between the air deflecting member and the attachment portion.

Clause 9. The refrigerator appliance of clause 8, wherein the illumination strip is located such that in use it is disposed within, or adjacent to, the air curtain passage.

Clause 10. The refrigerator appliance of clause 8 or clause 9, wherein the illumination strip is disposed on the attachment portion.

Clause 11. The refrigerator appliance of clause 10, wherein the attachment portion defines a cavity having a slot opening, and wherein the illumination strip is received within the cavity and directed to emit light through the slot opening.

Clause 12. The refrigerator appliance of clause 11, further comprising a removable cover defining a part of the cavity.

Clause 13. The refrigerator appliance of clause 12, wherein the removable cover is shaped to deflect the air curtain towards the air curtain passage.

Clause 14. The refrigerator appliance of clause 8 or clause 9, wherein the illumination strip is disposed on the air deflecting member.

Clause 15. The refrigerator appliance of clause 14, wherein the air deflecting member comprises a cavity and a slot opening, and wherein the illumination strip is received within the cavity and directed to emit light through the slot opening.

Clause 16. The refrigerator appliance of any one of clauses 8 to 15, further comprising an air outlet disposed at a top of the cabinet and arranged to generate an air curtain at the front of the cabinet.

Clause 17. The refrigerator appliance of any one of clauses 1 to 16, comprising a plurality of shelves, each shelf having a front edge and an illumination strip extending parallel to the front edge and disposed at or near the front edge to illuminate products on the at least one shelf.

Clause 18. An air curtain attachment for a refrigerator appliance, the air curtain attachment comprising:
an attachment portion for attaching to a front edge of a shelf of the refrigerator appliance,
an air deflecting member mounted to the attachment portion by support arm such that the air deflecting member is spaced from the attachment portion to define an air curtain passage between the air deflecting member and the attachment portion, and
an illumination strip arranged to illuminate products on the shelf when the air curtain attachment is attached to the front edge of the shelf by the attachment portion.

Clause 19. The air curtain attachment of clause 18, wherein the illumination strip is located such that in use it is disposed within, or adjacent to, the air curtain passage.

Clause 20. The air curtain attachment of clause 18 or clause 19, wherein the illumination strip is disposed on the attachment portion.

Clause 21. The air curtain attachment of clause 20, wherein the attachment portion defines a cavity having a slot opening, and wherein the illumination strip is housed within the cavity and directed to emit light through the slot opening.

Clause 22. The air curtain attachment of clause 21, further comprising a removable cover defining a part of the cavity.

Clause 23. The air curtain attachment of clause 22, wherein the removable cover is shaped to deflect the air curtain towards the air curtain passage.

Clause 24. The air curtain attachment of clause 18 or clause 19, wherein the illumination strip is disposed on the air deflecting member.

Clause 25. The air curtain attachment of clause 24, wherein the air deflecting member comprises a cavity having a slot opening, and wherein the illumination strip is housed within the cavity and directed to emit light through the slot opening.

1. A refrigerator appliance comprising a cabinet with at least one shelf for displaying products, and a refrigeration system for cooling the cabinet, wherein the at least one shelf comprises a front edge located at a front of the cabinet, and an illumination strip extending parallel to the front edge and disposed at or near the front edge to illuminate products on the at least one shelf.

2. The refrigerator appliance of claim 1, comprising a cavity extending along the front edge of the shelf, the cavity comprising a slot opening, and wherein the illumination strip is housed within the cavity and directed to emit light through the slot opening.

3. The refrigerator appliance of claim 2, wherein the illumination strip is attached to the front edge of the shelf, and wherein the refrigerator appliance further comprises a removable cover that is attachable to the front edge of the shelf to define the cavity.

4. The refrigerator appliance of claim 3, further comprising an air curtain attachment attachable to the front edge of the shelf adjacent to the illumination strip and removable cover.

5. The refrigerator appliance of claim 1, comprising an air curtain attachment attachable to the front edge of the shelf, the air curtain attachment comprising the illumination strip.

6. The refrigerator appliance of claim 5, wherein the air curtain attachment comprises an attachment portion for attaching to the front edge of the shelf, and an air deflecting member mounted to the attachment portion by a support arm such that the air deflecting member is spaced from the attachment portion to define an air curtain passage between the air deflecting member and the attachment portion.

7. The refrigerator appliance of claim 6, wherein the illumination strip is located such that in use it is disposed within, or adjacent to, the air curtain passage.

8. The refrigerator appliance of claim 6, wherein the illumination strip is disposed on the attachment portion.

9. The refrigerator appliance of claim 8, wherein the attachment portion defines a cavity having a slot opening, and wherein the illumination strip is received within the cavity and directed to emit light through the slot opening.

10. The refrigerator appliance of claim 9, further comprising a removable cover defining a part of the cavity.

11. The refrigerator appliance of claim 10, wherein the removable cover is shaped to deflect the air curtain towards the air curtain passage.

12. An air curtain attachment for a refrigerator appliance, the air curtain attachment comprising:
an attachment portion for attaching to a front edge of a shelf of the refrigerator appliance,
an air deflecting member mounted to the attachment portion by support arm such that the air deflecting member is spaced from the attachment portion to define an air curtain passage between the air deflecting member and the attachment portion, and
an illumination strip arranged to illuminate products on the shelf when the air curtain attachment is attached to the front edge of the shelf by the attachment portion.

13. The air curtain attachment of claim 12, wherein the illumination strip is located such that in use it is disposed within, or adjacent to, the air curtain passage.

14. The air curtain attachment of claim 12,
wherein the illumination strip is disposed on the attachment portion.

15. The air curtain attachment of claim 14, wherein the attachment portion defines a cavity having a slot opening, and wherein the illumination strip is housed within the cavity and directed to emit light through the slot opening, and further comprising a removable cover defining a part of the cavity.
